(19) United States
(12) Patent Application Publication
(10) Pub. No.: US 2019/0307226 A1
(43) Pub. Date: Oct. 10, 2019

(54) ATOMIZER

(71) Applicant: AIR SURF Inc., Tokyo (JP)

(72) Inventor: Satoru WASHIO, Tokyo (JP)

(21) Appl. No.: 16/314,927

(22) PCT Filed: Jul. 5, 2017
(86) PCT No.: PCT/JP2017/024697

§ 371 Date: Jan. 3, 2019

(30) Foreign Application Priority Data
Jul. 6, 2016 (JP) 2016-134510

(51) Int. Cl. A45D 34/04; B05B 7/28

(52) U.S. Cl. CPC A45D 34/04; A45D 2200/057; B05B 7/28

(57) ABSTRACT

The present invention addresses the problem of providing an atomizer that is easy to handle and that is particularly suitable for atomizing a cosmetic material. The present invention comprises: an atomizer body 2 that has a coating composition atomizing head 2a at a leading end thereof; a pressure tank 3 that is filled with a compressed gas; and a gas supply pipe 4 that supplies the pressurized gas to the atomizing body from the pressure tank. A composition supply tank 5 that supplies the coating composition and an operation part C that causes the coating composition to be sprayed from the atomizing head are provided between the leading end and a trailing end of the atomizer body. A substantially ovoid-shaped gripping part G that is gripped by the palm of a hand of a user is formed at the trailing end of the atomizer body.

### TECHNICAL FIELD

The present invention relates to an atomizer that is easy to handle.

### BACKGROUND ART

As a typical applicator of a conventional makeup cosmetic material for a skin, there are fingers, sponges, puffs, brushes, and the like.

Meanwhile, in recent years, it has also been proposed to atomize the makeup cosmetic materials.

For example, Patent Document 1 discloses a cosmetic method using a cosmetic material atomizer. The cosmetic material atomizer is provided with an airbrush which is an atomizer main body, a hollow gas hose interposed between the airbrush and a gas hose connector, and a compressor which supplies air to the airbrush. The airbrush is provided with a nozzle which ejects the cosmetic material, a cosmetic material-containing cup which supplies the cosmetic material, an adjusting lever which adjusts an ejection amount of the cosmetic material, and a gas hose connector which inserts the gas hose for air conveying.

### CITATION LIST

### Patent Document

Patent Document 1: JP 2013-42930 A

### SUMMARY OF THE INVENTION

### Problem to be Solved by the Invention

A conventional cosmetic material atomizer described in Patent Document 1 is a so-called gun type, which is a type of atomizing the cosmetic material by holding with a hand and pulling an adjusting lever with a finger, but the cosmetic material atomizer lacks in operability as an instrument that performs a delicate act of makeup. Also, in terms of directing the instrument towards the face, the gun type instruments have not been said to be preferable.

In particular, in the above-described conventional technique, when atomizing the cosmetic material, since there is a need to hold the atomizer main body with the fingertip and to operate the adjusting lever with the finger holding the atomizer main body, the atomizer main body is not stable in the holding hand, the operation is complicated, and there is an improvement in fluctuation of the coating direction.

The invention is made to solve the above-mentioned problems, and an object thereof is to provide an atomizer which is easy to handle, particularly suitable for atomizing the cosmetic material.

### Means for Solving Problem

In order to solve the above-mentioned problems, the invention provides an atomizer which atomizes a coating composition by a compressed gas, and includes an atomizer main body having an atomizing head for the coating composition at a leading end, a pressure tank filled with the compressed gas, and a gas supply pipe which supplies the compressed gas from the pressure tank to the atomizer main body. A composition supply tank for supplying the coating composition, and an operating section for spraying the coating composition from the atomizing head are provided between the leading end portion and a trailing end portion of the atomizer main body, and a substantially oval gripping section to be gripped by the palm of the user's hand is formed at the trailing end portion.

With such a configuration, the user of the atomizer holds the atomizer main body, by griping the gripping section formed at the trailing end portion of the atomizer main body so as to be wrapped with the palm of the hand.

Here, since the user can firmly grip the atomizer main body with the palm of the hand, it is possible to stably hold the atomizer main body.

The holding is mainly performed by a middle finger, a ring finger, and a little finger, and an index finger and the thumb are lightly put to the atomizer main body or free.

Further, in the state in which the atomizer is held, by operating the operating section with the thumb or the index finger which are almost in a free state as described above, the compressed gas in the pressure tank is supplied to the atomizer main body via the gas supply pipe. Thus, the coating composition in the composition supply tank can be atomized from the atomizing head of the atomizer main body.

In the atomizing operation, since the atomizer main body is stably held as described above, the coating composition can be stably atomized, and uniform coating can be performed.

Further, since the operating section is provided in a part in which a thumb or an index finger of the user is positioned in a state in which the user grips the gripping section, when the atomizer main body is gripped, the thumb or the index finger is made to spontaneously faces the operating section.

Accordingly, it is possible to operate the operating section, while holding the atomizer main body in a stable state, and it is possible to perform a more stable application operation.

On the other hand, a cover is provided to cover the pressure tank, a lower accommodating section which covers the pressure tank from above is formed in a lower part of the cover, the main body holding section is continuously provided in a tapered shape upward from the lower accommodating section, and a main body holding section to which a leading end portion of the atomizer main body is detachably mounted may be provided at an upper end portion of the main body holding section.

With this configuration, when the atomizer is not used, the atomizer main body can be inserted into the main body holding section formed at the upper end portion of the cover and stored therein.

Therefore, when the atomizer is not used, by integrating the atomizer main body with the pressure tank, it is possible to compactly store the atomizer.

In a case where the pressure tank is covered with the cover, it is preferable that a guide hole through which one end portion of the gas supply pipe is inserted be formed on a side surface of the cover.

This makes it easy to handle the gas supply pipe through which the pressure tank and the atomizer main body in the cover communicate with each other.

Further, a tank holding section to which the composition supply tank is detachably mounted may be formed on the side surface of the cover.

With such a configuration, the composition supply tank can be detached from the atomizer main body and attached to the cover at the time of non-use or the like.

Therefore, it is possible to prevent the composition supply tank from being lost at the time of cleaning and maintenance of the atomizer main body.

### Effect of the Invention

As described above, in the atomizer of the invention, stable holding can be performed by the user, and it is possible to perform the stable atomizing operation that is easy to handle.

### BRIEF DESCRIPTION OF DRAWINGS

FIG. 1 is a front view illustrating an embodiment of the invention;

FIG. 2 is a vertical sectional view illustrating an embodiment of the invention;

FIG. 3 is a plan view of an atomizer main body according to an embodiment of the invention;

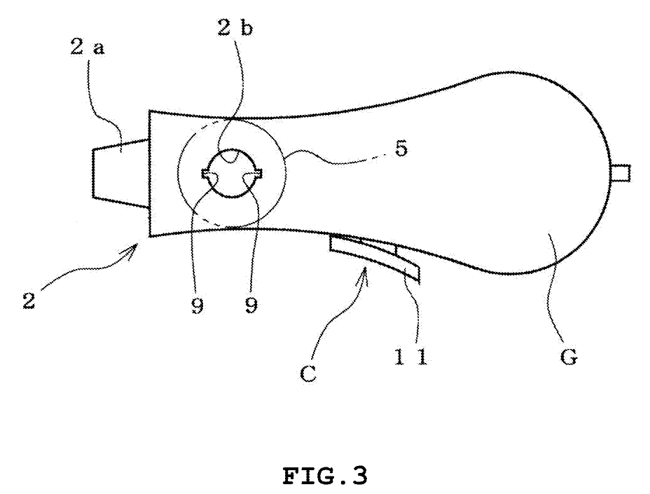

FIG. 4 is a side view of the atomizer main body according to an embodiment of the invention;

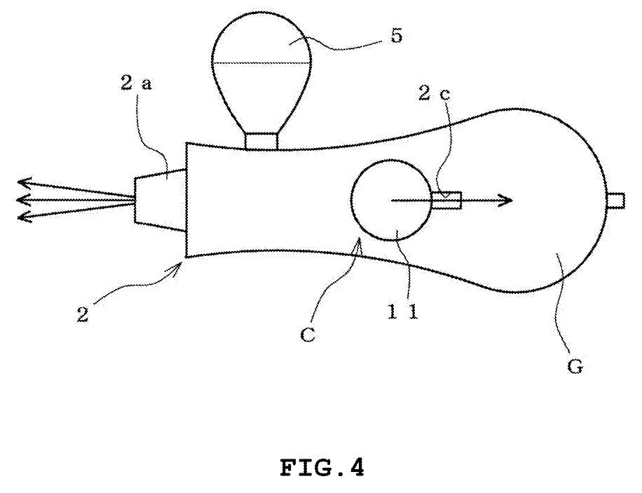

FIG. 5 is a plan view of a state in which the atomizer main body according to an embodiment of the invention is disassembled; and

FIG. 6 is a vertical sectional side view according to an embodiment of the invention.

### MODE(S) FOR CARRYING OUT THE INVENTION

Hereinafter, an embodiment of the invention will be described with reference to the drawings.

In the drawings, reference numeral 1 denotes an atomizer according to the present embodiment. The atomizer 1 is an atomizer 1 which atomizes a coating composition by a compressed gas, and includes an atomizer main body 2 having an atomizing head 2a of the coating composition at a leading end, a pressure tank 3 filled with the compressed gas, and a gas supply pipe 4 for supplying the compressed gas from the pressure tank 3 to the atomizer main body 2. A composition supply tank 5 for supplying the coating composition, and an operating section C for spraying the coating composition from the atomizing head 2a are provided between the leading end portion and a trailing end portion of the atomizer main body 2, and a substantially oval gripping section G to be gripped by the palm of the user's hand is formed at the trailing end portion.

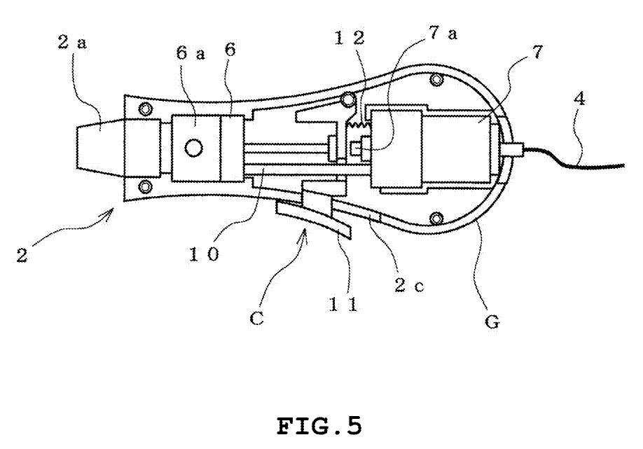

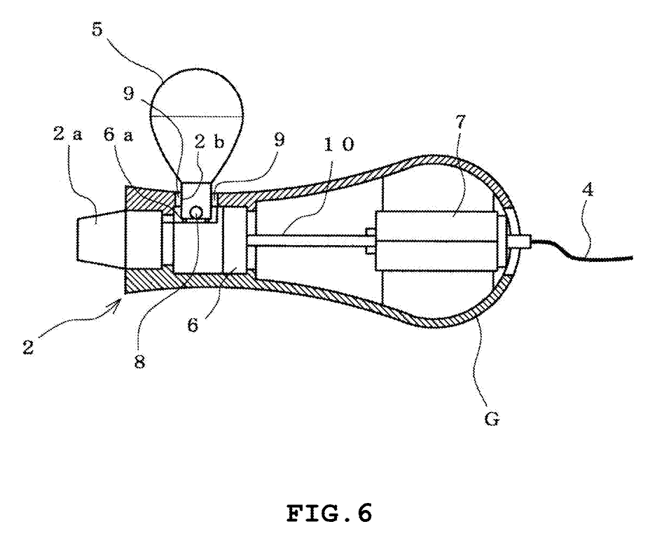

More specifically, the atomizer main body 2 is formed in a hollow shape, and as illustrated in FIGS. 5 and 6, the atomizing head 2a is incorporated at the leading end portion of the atomizer main body 2, a coupler 6 to which the composition supply tank 5 is detachably mounted is incorporated in the rear part of the atomizing head 2a, the operating section C is incorporated in the rear part of the coupler 6, and an opening/closing valve 7 which performs the supply and stop of the compressed gas is incorporated in the rear part of the operating section C.

A tank mounting section 6a, on which the composition supply tank 5 is mounted, is provided at a side portion of the coupler 6.

The tank mounting section 6a is exposed to the outside through a tank mounting hole 2b formed on the side wall of the atomizer main body 2.

Further, the coupler 6 is made to communicate with the atomizing head 2a, and in a state in which the composition supply tank 5 is mounted, the coating composition is supplied from the composition supply tank 5.

On the other hand, when the compressed gas is supplied to the atomizing head 2a, the compressed gas is sprayed from the leading end of the atomizing head 2a via the inside of the atomizing head 2a. Due to the flow of the compressed gas, the inside of the coupler 6 made to communicate with the atomizing head 2a is set to a negative pressure, and the coating composition supplied to the coupler 6 is sucked by the negative pressure, and is sprayed from the atomizing head 2a together with the compressed gas.

A cylindrical section to be inserted into a tank mounting hole 2b formed in the atomizer main body 2 is formed at a leading end portion of the composition supply tank 5, and an engaging protrusion 8 directed radially outward is provided to protrude from an outer surface of the cylindrical section (see FIG. 6).

The engaging protrusion 8 is adapted to be inserted through a notch 9 formed radially outward on the inner wall of the tank mounting hole 2b.

Further, after bringing the cylindrical section of the composition supply tank 5 to face the tank mounting hole 2b, the engaging protrusion 8 is inserted into the tank mounting hole 2b, while being inserted through the notch 9. Next, the composition supply tank 5 is rotated around the axis to engage the engaging protrusion 8 with the inner wall of the atomizer main body 2, thereby mounting the composition supply tank 5 to the tank mounting hole 2b, that is, the atomizer main body 2.

Also, by performing the above operation reversely, the composition supply tank 5 is detached from the atomizer main body 2.

The atomizing head 2a is made to communicate with the opening/closing valve 7 via the air supply pipe 10, and when the opening/closing valve 7 is released, the compressed gas in the pressure tank 3 is supplied. Further, the pressure tank 3 is provided with a supply valve of the compressed gas to the gas supply pipe 4. The supply valve is provided with an adjusting section for making it possible to adjust a supply amount of the compressed gas in a plurality of stages. As a result, it is also possible to inject a small amount of air from the atomizing head.

The operating section C includes an operating lever 11 disposed to straddle the middle of the air supply pipe 10.

As illustrated in FIG. 5, the operating lever 11 is supported inside the atomizer main body 2 at a proximal end portion thereof in a freely swingable manner, and the other end portion thereof is located outside the side wall of the atomizer main body 2 via a guide hole 2c formed along a lengthwise direction.

An intermediate section of the operating lever 11 is made to face an operation surface of an opening/closing rod 7a of the opening/closing valve 7, the pressing and releasing of the opening/closing rod 7a are performed, and the opening and closing of the opening/closing valve 7 is performed by the swinging motion.

Further, the operating lever 11 is urged in a direction in which the opening/closing valve 7 is set to a closed state by a compression spring 12 interposed between the operating lever 11 and the inner wall of the atomizer main body 2.

The other end portion of the operating lever 11 is provided at a part in which a thumb or an index finger of the user is positioned in a state in which a user grips the gripping section G.

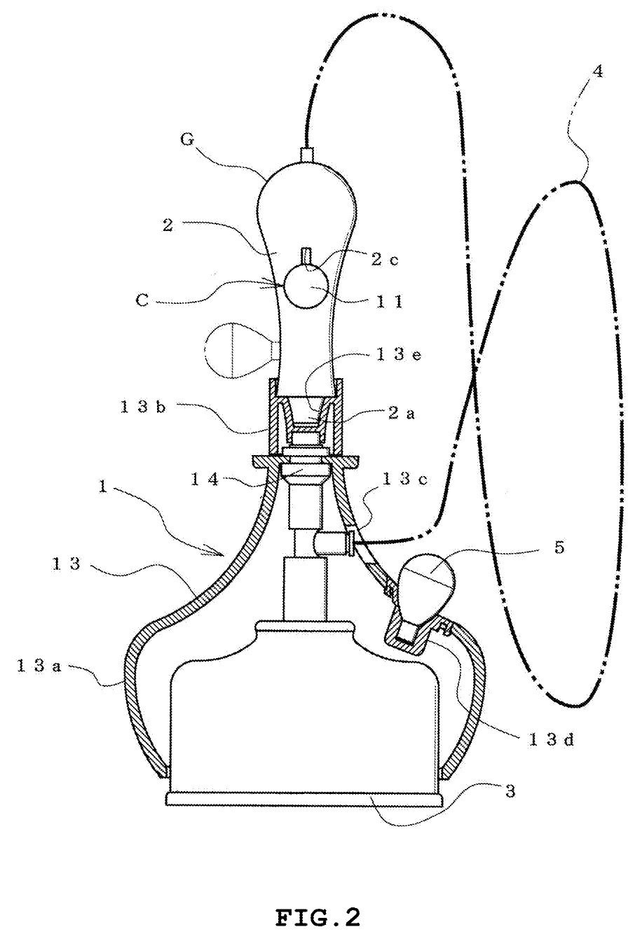

In the present embodiment, as illustrated in FIG. 2, a cover 13 is provided to cover the pressure tank 3, the cover 13 includes a lower accommodating section 13a which covers the pressure tank 3 from above in a lower part of the cover 13, the cover is continuously provided in a tapered shape upward from the lower accommodating section 13a, and a main body holding section 13b to which a leading end portion of the atomizer main body 2 is detachably mounted is provided at an upper end portion of the cover 13.

The cover 13 is fixed to the upper end portion of the pressure tank 3 via a locking tool 14 in the vicinity of the main body holding section 13b.

The locking tool 14 is made to protrude upward from the upper end portion of the lower accommodating section 13a, and the main body holding section 13b is attached to the protruding end thereof.

On the side surface of the cover 13, a guide hole 13c through which one end portion of the gas supply pipe 4 is inserted is formed, and a tank holding section 13d to which the composition supply tank 5 is detachably mounted is formed.

The tank holding section 13d is constituted by a recessed portion to which the leading end portion of the composition supply tank 5 is fitted.

Further, a recessed portion 13e which opens upward is formed in the main body holding section 13b, and the leading end of the composition supply tank 5 is fitted into the recessed portion 13e, and is supported by the cover 13 in an inverted state of the composition supply tank 5.

In the present embodiment, since the gripping section G of the atomizer main body 2 is formed in a substantially oval shape, when mounted on the cover 13, the external shape is formed into a shape connected by a smooth curve, and as a whole, a cosmetic bottle shape with the atomizer main body 2 as a stopper is provided.

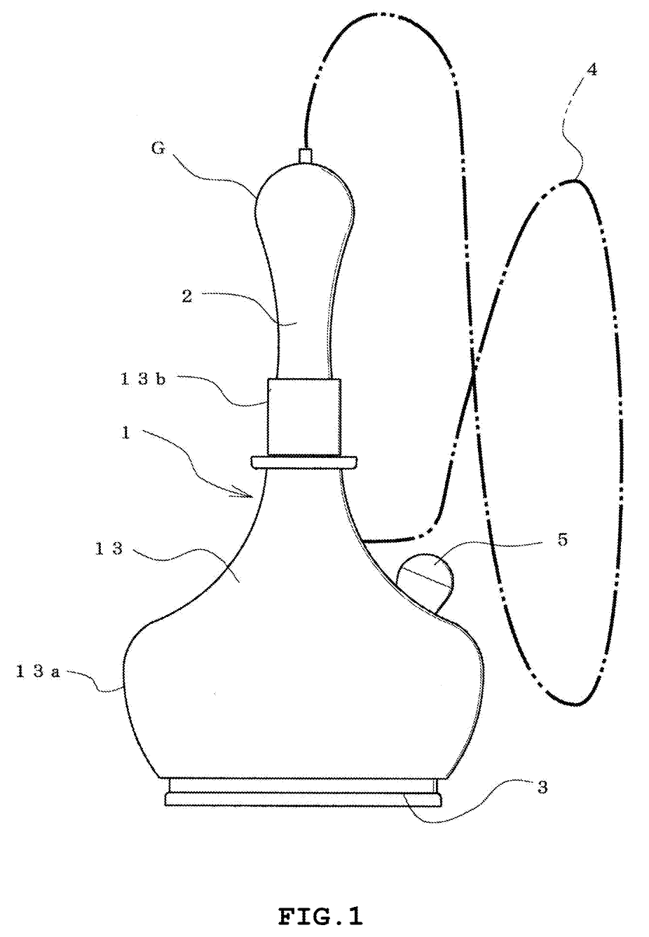

As illustrated in FIG. 1, the atomizer 1 according to the present embodiment thus configured is in a storage state by inserting the atomizer main body 2 into the main body holding section 13b of the cover 13.

In use, the atomizer main body 2 is detached from the cover 13, and the gripping section G thereof is gripped so as to be wrapped with the palm of the hand.

In this state, the index finger or the thumb of the gripped hand is superimposed on the operating lever 11 exposed on the side portion of the atomizer main body 2.

Thus, by operating the operating lever 11 in the state of gripping the atomizer main body 2, the opening/closing valve 7 is released, and the compressed gas in the pressure tank 3 is sent to the atomizing head 2a.

By supplying such compressed gas, a negative pressure region is formed in the rear part of the atomizer main body 2, and by the negative pressure, the coating composition filling the composition supply tank 5 mounted to the atomizer main body 2 is sucked into the atomizing head 2a via the coupler 6, and the atomizing head 2a is atomized.

Here, since the atomizer main body 2 is gripped so as to be wrapped with the palm of the user's hand, it is possible to secure a stable holding state, and in this embodiment, the thumb or index finger of the user is made to spontaneously face the operating lever 11 in the state of gripping.

Therefore, the user can reliably hold the atomizer main body 2 and can easily operate the operating lever 11.

As a result, a stable coating work can be performed.

On the other hand, after the use, the atomizer main body 2 is inserted into the main body holding section 13b of the cover 13 and stored therein in the state in which the composition supply tank 5 is mounted thereon.

Alternatively, the composition supply tank 5 is detached from the atomizer main body 2, and the composition supply tank 5 is transferred to the tank holding section 13d of the cover 13 and stored therein.

Detachment of the composition supply tank 5 from the atomizer main body 2 in this way is suitable when cleaning the interior of the coupler 6 of the atomizer main body 2 to prevent clogging after use.

It is to be noted that the shapes, dimensions, and the like of the constituent members illustrated in the above embodiments are merely examples, and various modifications can be made based on design requirements and the like.

### EXPLANATIONS OF LETTERS OR NUMERALS

1 ATOMIZER
2 ATOMIZER MAIN BODY
2a ATOMIZING HEAD
2b TANK MOUNTING HOLE
2c GUIDE HOLE
3 PRESSURE TANK
4 GAS SUPPLY PIPE
5 COMPOSITION SUPPLY TANK
6 COUPLER
6a TANK MOUNTING SECTION
7 OPENING/CLOSING VALVE
7a OPENING/CLOSING ROD
8 ENGAGING PROTRUSION
9 NOTCH
10 AIR SUPPLY PIPE
11 OPERATING LEVER
12 COMPRESSION SPRING
13 COVER
13a LOWER HOUSING SECTION
13b MAIN BODY HOLDING SECTION
13c GUIDE HOLE
13d TANK HOLDING SECTION
13e RECESSED PORTION
14 LOCKING TOOL
C OPERATING SECTION
G GRIPPING SECTION

1. An atomizer which atomizes a coating composition by a compressed gas, comprising: an atomizer main body having an atomizing head for the coating composition at a leading end; a pressure tank filled with the compressed gas; and a gas supply pipe configured to supply the compressed gas from the pressure tank to the atomizer main body,
wherein the atomizer main body is formed in a hollow shape, the atomizing head is incorporated at the leading end portion, a coupler to which a composition supply tank configured to supply the coating composition is detachably mounted is incorporated in a rear part of the atomizing head, an operating section configured to spray the coating composition from the atomizing head is incorporated in the rear part of the coupler, an opening/closing valve configured to perform supply and stop of the compressed gas is incorporated in the rear part of the operating section, at a trailing end portion of the atomizer main body, an external shape of the trailing end portion of the atomizer main body, into which the opening/closing valve is incorporated, is a substantially oval gripping section gripped by a palm of a user, and the atomizing head, the coupler, the operating section, and the opening/closing valve are arranged in a substantially straight line along an atomizing direction of the atomizer head.

2. The atomizer according to claim 1, wherein the operating section is provided in a part in which a thumb or an index finger of the user is positioned in a state in which the user grips the gripping section.

3. The atomizer according to claim 1, wherein a cover is provided to cover the pressure tank, a lower accommodating section which covers the pressure tank from above is formed in a lower part of the cover, the cover is continuously provided in a tapered shape upward from the lower accommodating section, and a main body holding section to which a leading end portion of the atomizer main body is detachably mounted is provided at an upper end portion of the cover.

4. The atomizer according to claim 3, wherein a guide hole through which one end portion of the gas supply pipe is inserted is formed on a side surface of the cover.

5. The atomizer according to claim 3, wherein a tank holding section to which the composition supply tank is detachably mounted is formed on the side surface of the cover.

6. The atomizer according to claim 2, wherein a cover is provided to cover the pressure tank, a lower accommodating section which covers the pressure tank from above is formed in a lower part of the cover, the cover is continuously provided in a tapered shape upward from the lower accommodating section, and a main body holding section to which a leading end portion of the atomizer main body is detachably mounted is provided at an upper end portion of the cover.

7. The atomizer according to claim 6, wherein a guide hole through which one end portion of the gas supply pipe is inserted is formed on a side surface of the cover.

8. The atomizer according to claim 6, wherein a tank holding section to which the composition supply tank is detachably mounted is formed on the side surface of the cover.

9. The atomizer according to claim 4, wherein a tank holding section to which the composition supply tank is detachably mounted is formed on the side surface of the cover.

10. The atomizer according to claim 7, wherein a tank holding section to which the composition supply tank is detachably mounted is formed on the side surface of the cover.
